(19) United States
(12) Patent Application Publication
(10) Pub. No.: US 2026/0290236 A1
(43) Pub. Date: Sep. 24, 2026

(54) PIXEL CIRCUIT AND DRIVING METHOD THEREFOR, AND DISPLAY APPARATUS AND DRIVING METHOD THEREFOR

(71) Applicants: Chengdu BOE Optoelectronics Technology Co., Ltd., Chengdu, Sichuan (CN); BOE Technology Group Co., Ltd., Beijing (CN)

(72) Inventors: Ziyang YU, Beijing (CN); Haijun QIU, Beijing (CN); Ming HU, Beijing (CN); Zhiliang JIANG, Beijing (CN); Tiaomei ZHANG, Beijing (CN)

(21) Appl. No.: 19/168,235

(22) PCT Filed: Sep. 5, 2024
(86) PCT No.: PCT/CN2024/117169

§ 371 Date: Sep. 23, 2025

(30) Foreign Application Priority Data
Oct. 20, 2023 (CN) 202311369829.4

(51) Int. Cl. G09G 3/3233

(52) U.S. Cl. CPC G09G 3/3233; G09G 2300/0819; G09G 2300/0842; G09G 2310/08

(57) ABSTRACT

A pixel circuit includes a driving transistor, a light-emitting device, a compensation sub-circuit, and a coupling sub-circuit; a first electrode of the driving transistor is coupled with a first power supply end and is configured to generate a driving current on the basis of a data voltage; the first power supply end is written with the data voltage and a first power supply voltage in a time-sharing manner; the compensation sub-circuit is coupled with a gate of the driving transistor and a second electrode of the driving transistor and is configured to connect the gate of the driving transistor and the second electrode of the driving transistor in response to a signal of a scan signal end; the coupling sub-circuit is coupled with the gate of the driving transistor; and the light-emitting device emits light under the action of the driving current.

### CROSS-REFERENCE TO RELATED APPLICATION

This application is a National Stage of International Application No. PCT/CN2024/117169, filed on Sep. 5, 2024, which claims priority to Chinese Patent Applications No. 202311369829.4, filed with the China National Intellectual Property Administration on Oct. 20, 2023, and entitled “Pixel Circuit and Driving Method Therefor, and Display Apparatus and Driving Method Therefor”, the content of which is hereby incorporated by reference in its entirety.

### TECHNICAL FIELD

The present disclosure relates to the technical field of display, and particularly to a pixel circuit, a display apparatus, and a driving method therefor.

### BACKGROUND

OLED pixels need to be driven by current to emit light, which requires high current stability of a driving transistor (Driving TFT, DTFT). However, DTFT fabricated by Low Temperature Poly-silicon (LTPS) process is generally not stable. The threshold voltage and the like are shifted by Excimer Laser Annealing (ELA) crystallization, long-time pressure, temperature change, and the like. A complex pixel circuit (e.g., 7T1C) design is required to compensate for the DTFT, to ensure that stable current is output by the DTFT under different working conditions, so that the display effect and the service life of the OLED display are ensured. However, the process capability of fabricating a display panel is limited, and as the pixel density unit (Pixels Per Inch, PPI) of the display panel increases, the 7T1C pixel circuit cannot be used to drive a high PPI display due to the large space occupied.

### SUMMARY

Embodiments of the present disclosure provide a pixel circuit, a display apparatus, and a driving method therefor, to achieve pixel driving function with fewer transistors, to reduce the space occupied by the circuit in the high PPI display panel.

Specific schemes according to the present disclosure are as follows.

In a first aspect, embodiments of the present disclosure provide a pixel circuit, including: a driving transistor, a light-emitting device, a compensation sub-circuit, and a coupling sub-circuit;
where a first electrode of the driving transistor is coupled with a first power supply end and is configured to generate a driving current according to a data voltage, where the first power supply end is written with the data voltage and a first power supply voltage in a time-sharing manner;
the compensation sub-circuit is coupled with a gate of the driving transistor and a second electrode of the driving transistor and is configured to connect the gate of the driving transistor and the second electrode of the driving transistor in response to a signal of a scan signal end; the coupling sub-circuit is coupled with the gate of the driving transistor and is configured to change a voltage of the gate of the driving transistor in response to a signal of a gating control end;
an anode of the light-emitting device is coupled with the second electrode of the driving transistor, a cathode of the light-emitting device is coupled with a second power supply end, and the light-emitting device is configured to emit light under an action of the driving current.

Optionally, the compensation sub-circuit includes: a first transistor;
a control end of the first transistor is coupled with the scan signal end, a first end of the first transistor is coupled with the gate of the driving transistor, and a second end of the first transistor is coupled with the anode of the light-emitting device.

Optionally, the coupling sub-circuit includes: a first capacitor;
a first end of the first capacitor is coupled with the gating control end, and a second end of the first capacitor is coupled with the gate of the driving transistor.

Optionally, the pixel circuit further includes a reset sub-circuit;
where the reset sub-circuit is coupled with the anode of the light-emitting device and is configured to provide an initialization signal at an initialization signal end to the anode of the light-emitting device and the gate of the driving transistor in response to a signal of a reset signal end.

Optionally, the reset sub-circuit includes: a second transistor;
a control end of the second transistor is coupled with the reset signal end, a first end of the second transistor is coupled with the anode of the light-emitting device, and a second end of the second transistor is coupled with the initialization signal end.

Optionally, the first transistor is a single-gate transistor or a dual-gate transistor;
based on that the first transistor is the dual-gate transistor, a first gate of the first transistor is coupled with the scan signal end, and a second gate of the first transistor is coupled with the scan signal end.

Optionally, the initialization signal end and the gating control end are the same signal end.

In a second aspect, embodiments of the present disclosure further provide a display panel, including: a plurality of pixels, where each of the plurality of pixels includes any one of the above pixel circuits.

Optionally, the display panel includes a gating signal line;
where the gating control end of each of the plurality of pixels is coupled with the same gating signal line.

Optionally, the display panel includes: a plurality of reset lines and a plurality of gate lines where reset signal ends of pixel circuits in a row of pixels are coupled with one of the plurality of reset lines, and gate control ends in a row of pixels are coupled with one of the plurality of gate lines.

Optionally, a reset control circuit is coupled with the reset lines, a gate driving circuit is coupled with the gate lines, and a source driving circuit is coupled with a gating signal line.

In a third aspect, embodiments of the present disclosure further provide a display apparatus, including: any one of the above display panels.

In a fifth aspect, embodiments of the present disclosure further provide a driving method for any one of the above pixel circuits, including:
in a reset stage: a reset sub-circuit providing an initialization signal to the gate of the driving transistor and the anode of the light-emitting device in response to a signal of a reset signal end;
in a data writing stage: the compensation sub-circuit connecting the gate of the driving transistor and the second electrode of the driving transistor in response to the signal of the scan signal end;
in a light-emitting stage: the coupling sub-circuit changes the voltage of the gate of the driving transistor in response to the signal of the gating control end, so that the driving transistor generates the driving current according to the data voltage and the light-emitting device emits light under the action of the driving current.

In a sixth aspect, embodiments of the present disclosure further provide a driving method for any one of the display panels, including:
each display frame includes a first stage and a second stage, the driving method includes: driving the pixel circuit in each pixel row by row to perform the reset stage and the data writing stage in the first stage;
controlling the pixel circuit in each pixel to perform the light-emitting stage in the second stage.

Beneficial effects of the present disclosure are as follows.

In summary, embodiments of the present disclosure provide a pixel circuit, a display apparatus, and a driving method therefor, the pixel circuit includes: a driving transistor, a light-emitting device, a compensation sub-circuit and a coupling sub-circuit. A first electrode of the driving transistor is coupled with a first power supply end and is configured to generate a driving current according to a data voltage. The first power supply end is written with the data voltage and a first power supply voltage in a time-sharing manner. The compensation sub-circuit is coupled with a gate of the driving transistor and a second electrode of the driving transistor, and is configured to connect the gate of the driving transistor and the second electrode of the driving transistor in response to a signal of a scan signal end. The coupling sub-circuit is coupled with the gate of the driving transistor and is configured to change a voltage of the gate of the driving transistor in response to a signal of a gating control end. The light-emitting device emits light under an action of the driving current. The pixel circuit can realize the pixel driving function through a small number of transistors and capacitors, the space occupied by the circuit is reduced in a high PPI display.

Other features and advantages of the present disclosure will be described in the following description, and in part will become apparent from the description, or may be learned through implementation of the present disclosure. The purpose and other advantages of the present disclosure can be achieved and obtained through structures indicated in the written description, claims, and drawings.

### BRIEF DESCRIPTION OF FIGURES

The accompanying drawings, which are described herein to provide a further understanding of the present disclosure, are incorporated in and constitute a part of the present disclosure. Illustrative embodiments of the present disclosure and the description thereof are intended to be illustrative of the present disclosure and are not intended to be unduly limiting of the present disclosure.

FIG. 1 is a connection schematic diagram of a pixel circuit according to an embodiment of the present disclosure;

FIG. 2 is a connection schematic diagram of another pixel circuit according to an embodiment of the present disclosure;

FIG. 3 is a circuit connection diagram of a pixel circuit according to an embodiment of the present disclosure;

FIG. 4 is a timing diagram of a pixel circuit according to an embodiment of the present disclosure;

FIG. 5 is a connection diagram of a display panel according to an embodiment of the present disclosure;

FIG. 6 is a flowchart of a driving method for a pixel circuit according to an embodiment of the present disclosure;

FIG. 7 is a flowchart of a driving method for a display panel according to an embodiment of the present disclosure.

### DETAILED DESCRIPTION

For making objectives, technical solutions and advantages of embodiments of the present disclosure clearer, technical solutions of embodiments of the present disclosure will be clearly and completely described below in conjunction with accompanying drawings in embodiments of the present disclosure. Apparently, embodiments described are some rather than all of embodiments of the present disclosure. Embodiments in the present disclosure and features of embodiments may be combined with each other without conflict. Based on embodiments of the present disclosure, all other embodiments obtained by those of ordinary skill in the art without making creative efforts fall within the scope of protection of the present disclosure.

Terms “first”, “second”, etc. in the specification and claims of the present disclosure and the accompanying drawings are used to distinguish similar objects and do not necessarily need to be used to describe a specific order or sequence. It should be understood that the data used in this way can be interchanged in appropriate circumstances, so that embodiments of the present disclosure described herein can be implemented in a sequence other than those illustrated or described herein.

In the related art, OLED pixels need to be driven by current to emit light, which requires high current stability of a driving transistor (Driving TFT, DTFT). However, DTFT fabricated by LTPS process is generally not stable. The threshold voltage and the like are shifted by ELA crystallization, long-time pressure, temperature change, and the like. A complex pixel circuit (e.g., 7T1C) design is required to compensate for the DTFT, to ensure that stable current is output by the DTFT under different working conditions, so that the display effect and the service life of the OLED display are ensured.

However, the process capability of fabricating a display panel is limited, and as the pixel density unit (Pixels Per Inch, PPI) of the display panel increases, the 7T1C pixel circuit cannot be used to drive a high PPI display due to the large space occupied. For example, in a display panel with a PPI higher than 600, a pixel size of the 7T1C pixel circuit cannot provide enough layout space, and the pixel design cannot be completed.

Embodiments of the present disclosure will now be described in detail with reference to the accompanying drawings.

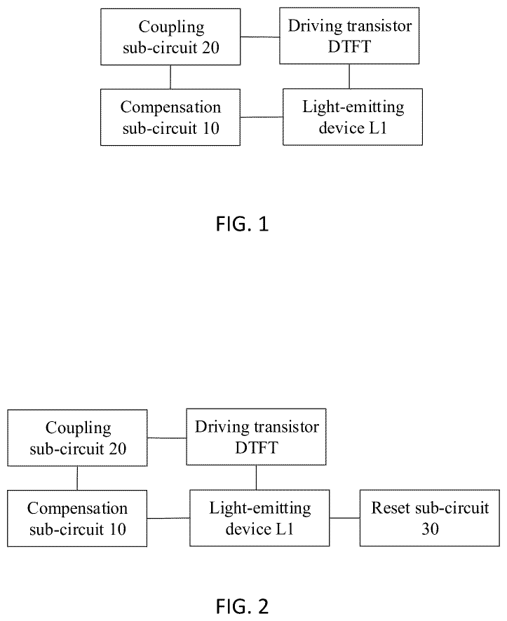

Referring to FIG. 1 and FIG. 2, a pixel circuit according to an embodiment of the present application includes: a driving transistor DTFT, a light-emitting device L1, a compensation sub-circuit 10 and a coupling sub-circuit 20.

A first electrode of the driving transistor DTFT is coupled with a first power supply end, and is configured to generate a driving current according to a data voltage Data. The first power supply end is written with the data voltage Data and a first power supply voltage ELVDD in a time-sharing manner.

In an embodiment of the present application, the driving transistor DTFT is multiplexed. When the first power supply end is written with the data voltage Data, the data voltage Data is written to the gate of the driving transistor DTFT after passing through the first electrode of the driving transistor DTFT, so that the driving transistor DTFT generates the driving current according to the data voltage Data. When the first power supply end is written with the first power supply voltage ELVDD, the driving transistor DTFT transmits the driving current to the light-emitting device L1 under the action of the first power supply voltage ELVDD and a second power supply voltage, to cause the light-emitting device L1 to emit light.

The compensation sub-circuit 10 is coupled with the gate of the driving transistor DTFT and a second electrode of the driving transistor DTFT, and is configured to connect the gate of the driving transistor DTFT and the second electrode of the driving transistor DTFT in response to a signal of a scan signal end Gate.

In an embodiment of the present application, when the signal of the scan signal end Gate is active, the compensation sub-circuit 10 is turned on. At this time, the first power supply end is written with the data voltage Data, and the data voltage Data is provided to the gate of the driving transistor DTFT by the first electrode of the driving transistor DTFT and the compensation sub-circuit 10 turned on.

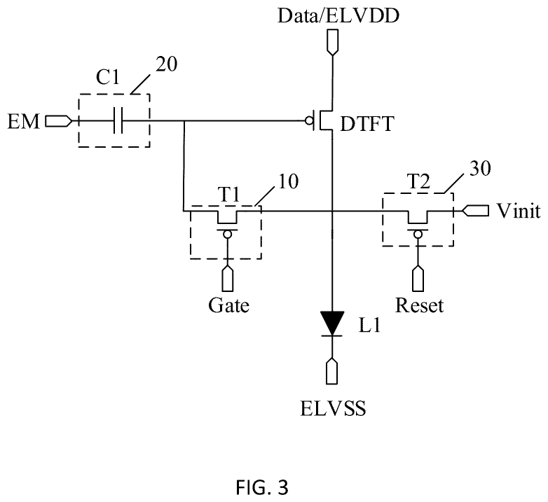

Referring to FIG. 3, the compensation sub-circuit 10 includes a first transistor T1.

Connection relationships between the first transistor T1 and other components in FIG. 3 are: a control end of the first transistor T1 is coupled with the scan signal end Gate, a first end of the first transistor T1 is coupled with the gate of the driving transistor DTFT, and a second end of the first transistor T1 is coupled with an anode of the light-emitting device L1.

In an implementation process, when the signal of the scan signal end Gate is at a low level, the first transistor T1 is turned on. The data voltage Data is provided to the anode of the light-emitting device L1 through the driving transistor DTFT turned on, and is provided to the gate of the driving transistor DTFT through the first transistor T1 turned on.

The first transistor T1 is a single-gate transistor or a dual-gate transistor.

When the first transistor T1 is a dual-gate transistor, a first gate of the first transistor T1 is coupled with the scan signal end Gate, and a second gate of the first transistor T1 is coupled with the scan signal end Gate.

The first transistor T1 is a dual-gate transistor, i.e., an additional gate (i.e., a second gate) is added between the source and the gate to form a dual-gate structure. In this way, when the voltage between the source and the gate is zero, the second gate is capable of attracting charges between the source and the drain, reducing leakage current.

The coupling sub-circuit 20 is coupled with the gate of the driving transistor DTFT, and is configured to change a voltage of the gate of the driving transistor DTFT in response to a signal of a gating control end EM.

Referring to FIG. 3, the coupling sub-circuit 20 includes a first capacitor C1.

Connection relationships between the first capacitor C1 and other components in FIG. 3 are: a first end of the first capacitor C1 is coupled with the gating control end EM, and a second end of the first capacitor C1 is coupled with the gate of the driving transistor DTFT.

In an implementation process, when the signal of the gating control end EM fluctuates, the first capacitor C1 couples a stored voltage to the gate of the driving transistor DTFT, to change the voltage of the gate of the driving transistor DTFT.

An anode of the light-emitting device L1 is coupled with the second electrode of the driving transistor DTFT, and a cathode of the light-emitting device L1 is coupled with a second power supply end ELVSS. The light-emitting device is configured to emit light under an action of the driving current.

In an implementation process, when the first power supply end is written with the first power supply voltage ELVDD, the driving transistor DTFT and the light-emitting device L1 are connected under the first power supply voltage ELVDD and the second power supply voltage, causing the light-emitting device L1 to emit light under the action of the driving current.

In addition, referring to FIG. 3, the pixel circuit further includes a reset sub-circuit 30.

In an embodiment of the present application, in order to reset the anode of the light-emitting device L1 and the gate of the driving transistor DTFT, the reset sub-circuit 30 is coupled with the anode of the light-emitting device L1, and is configured to provide an initialization signal Vinit to the anode of the light-emitting device L1 and the gate of the driving transistor DTFT in response to a signal of a reset signal end Reset.

Referring to FIG. 3, the reset sub-circuit 30 includes a second transistor T2.

Connection relationships between the second transistor T2 and other components in FIG. 3 are: a control end of the second transistor T2 is coupled with the reset signal end Reset, a first end of the second transistor T2 is coupled with the anode of the light-emitting device L1, and a second end of the second transistor T2 is coupled with an end of the initialization signal Vinit.

When the signal of the reset signal end Reset is at a low level, the second transistor T2 is turned on. The initialization signal Vinit at the end of the initialization signal Vinit is provided to the anode of the light-emitting device L1 through the second transistor T2 turned on, and is provided to the gate of the driving transistor DTFT through the first transistor T1 turned on, to realize resetting of the anode of the light-emitting device L1 and the gate of the driving transistor DTFT.

It should be added that, in order to save space, the end of the initialization signal Vinit and the gating control end EM are the same signal end. That is, in an initialization stage, the gating control end EM is an active signal, and the active signal is applied to the gate of the second transistor T2.

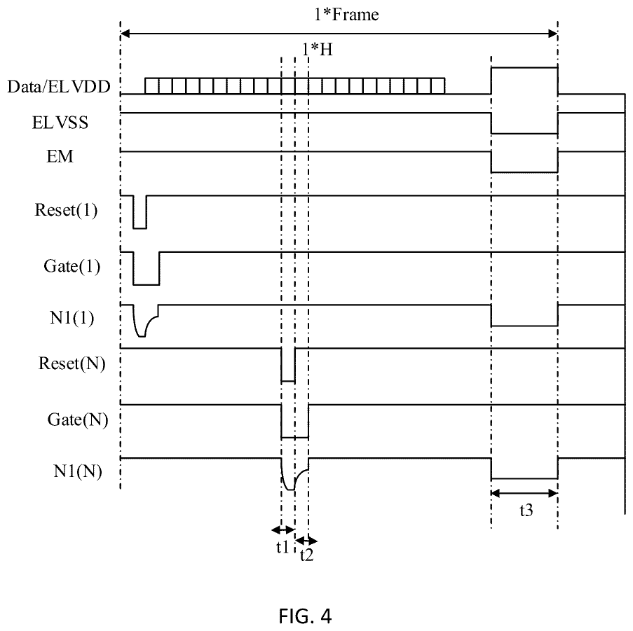

A working process of the pixel circuit according to an embodiment of the present application is described in detail below with reference to the timing diagram in FIG. 4.

Timing t1 stage: Data=1, ELVDD is inactive, ELVSS is inactive, EM=1, Reset=0, Gate=0.

When the reset signal end Reset is at a low level, the second transistor T2 is turned on. A signal at the end of the initialization signal Vinit resets the anode of the light-emitting device L1. When the scan signal end Gate is at a low level, the first transistor T1 is turned on. The signal at the end of the initialization signal Vinit is provided to the gate of the driving transistor DTFT through the anode of the light-emitting device L1 and the first transistor T1 turned on, to achieve resetting of the gate of the driving transistor DTFT.

Timing t2 stage: Data=1, ELVDD is inactive, ELVSS is inactive, EM=1, Reset=1, Gate signal changes from low to high, data voltage Data is written into the first power supply end connected with the first electrode of the driving transistor DTFT.

After the gate of the driving transistor DTFT is reset, the driving transistor DTFT is turned on. When the scan signal end Gate is at a low level, the first transistor T1 is turned on. The data voltage Data is provided to the gate of the driving transistor DTFT through the driving transistor DTFT and the first transistor T1 turned on. It should be noted that the driving transistor DTFT and the first transistor T1 turned on form a diode. The voltage of the gate of the driving transistor DTFT, i.e., the second end of the first capacitor C1, is discharged to the first power supply end. Finally, the voltage of the gate of the driving transistor DTFT, i.e., the second end of the first capacitor C1, is the sum of the data voltage Data and a threshold voltage of the driving transistor DTFT, i.e., Vdata+Vth. After the Gate signal changes from low to high, the second end of the first capacitor C1 and the first transistor T1 are in an unconnected state. The voltage of the second end of the first capacitor C1 is floating, and the voltage Vdata+Vth is stored in the first capacitor C1.

Timing t3 stage: Data=1, ELVDD is inactive, ELVSS is inactive, EM changes from high to low, Reset=1, Gate=1.

When the signal of the gating control end EM changes from a high level to a low level, the first capacitor C1 couples a level at the gate of the driving transistor DTFT to Vdata+Vth+ (VEMlow-VEMhigh). At the same time, an input end of the first power supply end is written with the first power supply voltage ELVDD, in combination with the second power supply voltage ELVSS of the second power supply end ELVSS, the gate-source voltage Vgs of the driving transistor DTFT equals to VN1−ELVDD=Vdata+Vth+(VEMlow−VEMhigh)−ELVDD, a driving current formula (1)

$$id = \frac{1}{2} * μ * {C}_{ox} * \frac{W}{L} * {( {V}_{gs} - {V}_{th} )}^{2}$$

is generated, and is further converted into a formula (2)

$$id = \frac{k}{2} {( {V}_{data} + ( VEMlow - VEMhigh ) - ELVDD )}^{2} .$$

As can be seen from the formula (2), the threshold voltage Vth of the driving transistor DTFT is not included in the driving current, to complete compensation of the threshold voltage Vth. Where VEMlow represents an initial low potential of the gating control end EM, VEMhigh represents an initial high potential of the gating control end EM. That is, the influence of the potential fluctuation of the gating control end EM itself is added in the generation process of the driving current, so that the driving current is more accurate.

Based on the same inventive concept, embodiments of the present disclosure provide a display panel including a plurality of pixels. Each of the plurality of pixels includes the pixel circuit according to any one of the above pixel circuits.

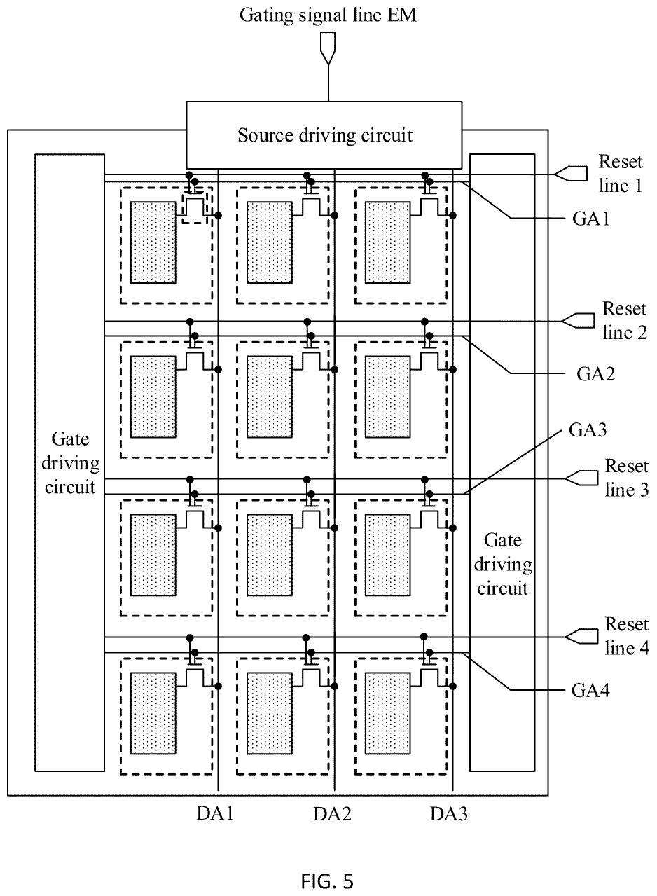

Referring to FIG. 5, the display panel may include a plurality of pixels arranged in an array, a plurality of gate lines GA (e.g., GA1, GA2, GA3, GA4), a plurality of data lines DA (e.g., DA1, DA2, DA3), a plurality of reset lines (e.g., reset line 1, reset line 2, reset line 3, and reset line 4), a gate driving circuit and a source driving circuit. The gate driving circuit is coupled with the gate lines GA1, GA2, GA3, GA4 respectively, and the source driving circuit is coupled with the data lines DA1, DA2, DA3 respectively. In an implementation process, a timing controller may input a control signal to the gate driving circuit through a Level Shift circuit, to drive the gate lines GA1, GA2, GA3, and GA4. The timing controller inputs a signal to the source driving circuit for the source driving circuit to input a data voltage Data to a data line, to charge the pixel, so that the pixel is input with the corresponding data voltage Data to realize the image display function. For example, two source driving circuits can be arranged. One of the source driving circuits is connected with half of the data lines, and the other source driving circuit is connected with the other half of the data lines. Of course, three, four or more source driving circuits can be arranged, which can be designed and determined according to the actual application requirements, and is not limited herein.

Illustratively, referring to FIG. 5, a pixel circuit is included in each pixel. One row of pixels corresponds to one gate line, and one column of pixels corresponds to one data line. A gate of a transistor is electrically connected with a corresponding gate line, a source electrode of the transistor is electrically connected with a corresponding data line, and a drain of the transistor is electrically connected with a pixel electrode.

Referring to FIG. 5, the display panel includes a gating signal line.

The gating control end EM of each pixel circuit is coupled with the same gating signal line.

In an embodiment of the present application, the gating control end EM (i.e., the source driver circuit) of each pixel circuit is electrically connected with the same gating signal line. In this way, after initialization and writing of the data voltage Data are completed, each pixel emits light under control of the gating signal line.

Referring to FIG. 5, the display panel includes a plurality of reset lines and a plurality of gate lines.

Reset signal ends of pixel circuits in a row of pixels are coupled with one reset line, and gate control ends in a row of pixels are coupled with one gate line.

Referring to FIG. 5, a reset control circuit is coupled with the reset lines, a gate driving circuit is coupled with the gate lines, and a source driving circuit is coupled with the gating signal line.

In addition, reset signal ends Reset of pixel circuits in a row of pixels are electrically connected with one reset line. By electrically connecting the reset control circuit with the reset line, and introducing the signal in the reset line to the reset signal end Reset of the pixel circuit of the corresponding row, resetting of the anode of the light-emitting device L1 and the gate of the driving transistor DTFT of the row of pixels are realized. It should be noted that the pixel array structure of the present disclosure may also be a dual-gate structure, that is, two gate lines are arranged between two adjacent rows of pixels. This arrangement mode can reduce half of the data lines, namely data lines between some adjacent two columns of pixels are included, data lines between some adjacent two columns of pixels are not included, and the specific pixel arrangement structure and the arrangement mode of data lines and scan lines are not limited.

Based on the same inventive concept, an embodiment of the present disclosure provides a display apparatus including the display panel according to any one of the above display panels.

In an embodiment of the present disclosure, the display apparatus may be any product or part that has a display function, such as a mobile phone, a tablet computer, a television, a display, a notebook computer, a digital photo frame, a navigator and the like. Other essential components of the display apparatus are as will be understood by those skilled in the art, are not described in detail herein, and should not be taken as a limitation on the present disclosure.

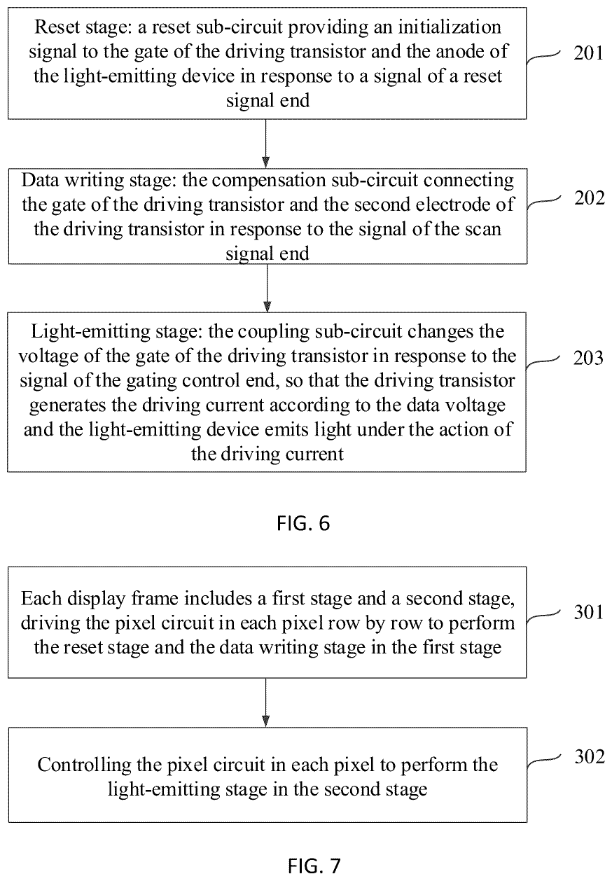

Based on the same inventive concept, an embodiment of the present disclosure provides a driving method for a pixel circuit, as shown in FIG. 6, including following steps.

Step 201: in a reset stage: a reset sub-circuit 30 provides an initialization signal Vinit to the gate of the driving transistor DTFT and the anode of the light-emitting device L1 in response to a signal of a reset signal end Reset.

During implementation, in the reset stage, when the signal at the reset signal end Reset is active (i.e., the signal at the reset signal end Reset is at a low level), the reset sub-circuit 30 is turned on. The initialization signal Vinit at the end of the initialization signal Vinit is provided to the gate of the driving transistor DTFT and the light-emitting device L1 through the reset sub-circuit 30 turned on, to achieve resetting of the gate of the driving transistor DTFT and the anode of the light-emitting device L1.

Step 202: in a data writing stage: the compensation sub-circuit 10 connects the gate of the driving transistor DTFT and the second electrode of the driving transistor DTFT in response to the signal of the scan signal end Gate.

In the data writing stage, when the signal of the scan signal end Gate is active (i.e., the signal of the scan signal end Gate is at a low level), the compensation sub-circuit 10 is turned on, the gate of the driving transistor DTFT and the second electrode of the driving transistor DTFT are connected. In this stage, a data voltage Data is written into the first power supply end to which the first electrode of the driving transistor DTFT is connected. The data voltage Data is written into the gate of the driving transistor DTFT through first electrode of the driving transistor DTFT and the compensation sub-circuit 10 turned on, to realize writing of the data voltage Data.

Step 203: in a light-emitting stage: the coupling sub-circuit 20 changes the voltage of the gate of the driving transistor DTFT in response to the signal of the gating control end EM, so that the driving transistor DTFT generates the driving current according to the data voltage Data and the light-emitting device L1 emits light under the action of the driving current.

In the light-emitting stage, when the signal of the gating control end EM is active (i.e., the signal of the gating control end EM is at a low level), the coupling sub-circuit 20 is turned on, and under the action of the coupling sub-circuit 20, the voltage of the gate of the driving transistor DTFT becomes Vdata+Vth. The driving transistor DTFT further generates the driving current according to the above formulas (1) and (2). In this way, the light-emitting device L1 emits light under the action of the driving current.

Based on the same inventive concept, an embodiment of the present disclosure provides a driving method for a display panel, as shown in FIG. 7, including following steps.

Step 301: each display frame includes a first stage and a second stage, the pixel circuit in each pixel is driven row by row to perform a reset stage and a data writing stage in the first stage.

One display frame includes a plurality of rows of pixels, for example, N1 (1), N1 (2) . . . . N1(N). In an implementation process, each row of pixels in a display frame firstly performs a reset stage and a data writing stage before light emission. That is, the reset sub-circuit 30 and the compensation sub-circuit 10 in the pixel circuit in each pixel are driven row by row to be turned on in the first stage, to first realize resetting of the gate of the driving transistor DTFT and the anode of the light-emitting device L1 of each pixel circuit in a unified manner, and realize writing of the data voltage Data.

Step 302: the pixel circuit in each pixel is controlled to perform the light-emitting stage in the second stage.

After each pixel circuit completes the first stage, the pixel circuit in each pixel is controlled to perform the light-emitting stage in the second stage. That is, the coupling sub-circuit 20 is controlled to be turned on, and under the action of the coupling sub-circuit 20, the voltage of the gate of the driving transistor DTFT generates the driving current. In this way, the light-emitting device L1 emits light under the action of the driving current.

In summary, embodiments of the present disclosure provide a pixel circuit, a display apparatus, and a driving method therefore. The pixel circuit includes: a driving transistor, a light-emitting device, a compensation sub-circuit and a coupling sub-circuit. A first electrode of the driving transistor is coupled with a first power supply end and is configured to generate a driving current according to a data voltage. The first power supply end is written with the data voltage and a first power supply voltage in a time-sharing manner. The compensation sub-circuit is coupled with a gate of the driving transistor and a second electrode of the driving transistor, and is configured to connect the gate of the driving transistor and the second electrode of the driving transistor in response to a signal of a scan signal end. The coupling sub-circuit is coupled with the gate of the driving transistor and is configured to change a voltage of the gate of the driving transistor in response to a signal of a gating control end. The light-emitting device emits light under an action of the driving current. The pixel circuit can realize the pixel driving function through a small number of transistors and capacitors, the space occupied by the circuit is reduced in a high PPI display.

Those skilled in the art should understand that embodiments of the present disclosure can be provided as methods, systems or computer program products. Therefore, the present disclosure can adopt forms of full hardware embodiments, full software embodiments, or embodiments combining software and hardware aspects. Moreover, the present disclosure can adopt a form of the computer program products implemented on one or more computer available storage mediums (including but not limited to a disk memory, a CD-ROM, an optical memory and the like) containing computer available program codes.

The present disclosure is described with reference to flow charts and/or block diagrams of the methods, the equipment (systems), and the computer program products according to embodiments of the present disclosure. It should be understood that each flow and/or block in the flow charts and/or the block diagrams and combinations of the flows and/or the blocks in the flow charts and/or the block diagrams can be implemented by computer program instructions. The computer program instructions may be provided to a processor of a general-purpose computer, a special-purpose computer, an embedded processing machine or other programmable data processing equipment, thereby generating a machine, such that the instructions, when executed by the processor of the computers or other programmable data processing equipment, generate devices for implementing functions specified in one or more flows in the flow charts and/or one or more blocks in the block diagrams.

The computer program instructions may also be stored in a computer readable memory which can guide the computers or other programmable data processing equipment to work in a specific mode, thus the instructions stored in the computer readable memory generates an article of manufacture that includes a commander device that implement the functions specified in one or more flows in the flow charts and/or one or more blocks in the block diagrams.

The computer program instructions may also be loaded to the computers or other programmable data processing equipment, so that a series of operating steps may be executed on the computers or other programmable equipment to generate computer-implemented processing, such that the instructions executed on the computers or other programmable equipment provide steps for implementing the functions specified in one or more flows in the flow charts and/or one or more blocks in the block diagrams.

Obviously, those skilled in the art can make various modifications and variations to the present disclosure without departing from the spirit and scope of the present disclosure. In this way, if these modifications and variations of the present disclosure fall within the scope of the claims of the present disclosure and their equivalent art, the present disclosure also intends to include these modifications and variations.

1. A pixel circuit, comprising: a driving transistor, a light-emitting device, a compensation sub-circuit, and a coupling sub-circuit;
wherein a first electrode of the driving transistor is coupled with a first power supply end and is configured to generate a driving current according to a data voltage, wherein the first power supply end is written with the data voltage and a first power supply voltage in a time-sharing manner;
the compensation sub-circuit is coupled with a gate of the driving transistor and a second electrode of the driving transistor and is configured to connect the gate of the driving transistor and the second electrode of the driving transistor in response to a signal of a scan signal end;
the coupling sub-circuit is coupled with the gate of the driving transistor and is configured to change a voltage of the gate of the driving transistor in response to a signal of a gating control end;
an anode of the light-emitting device is coupled with the second electrode of the driving transistor, a cathode of the light-emitting device is coupled with a second power supply end, and the light-emitting device is configured to emit light under an action of the driving current.

2. The pixel circuit according to claim 1, wherein the compensation sub-circuit comprises: a first transistor;
a control end of the first transistor is coupled with the scan signal end, a first end of the first transistor is coupled with the gate of the driving transistor, and a second end of the first transistor is coupled with the anode of the light-emitting device.

3. The pixel circuit according to claim 1, wherein the coupling sub-circuit comprises: a first capacitor;
a first end of the first capacitor is coupled with the gating control end, and a second end of the first capacitor is coupled with the gate of the driving transistor.

4. The pixel circuit according to claim 1, further comprising a reset sub-circuit;
wherein the reset sub-circuit is coupled with the anode of the light-emitting device and is configured to provide an initialization signal at an initialization signal end to the anode of the light-emitting device and the gate of the driving transistor in response to a signal of a reset signal end.

5. The pixel circuit according to claim 4, wherein the reset sub-circuit comprises: a second transistor;
a control end of the second transistor is coupled with the reset signal end, a first end of the second transistor is coupled with the anode of the light-emitting device, and a second end of the second transistor is coupled with the initialization signal end.

6. The pixel circuit according to claim 2, wherein the first transistor is a single-gate transistor or a dual-gate transistor;
based on that the first transistor is the dual-gate transistor, a first gate of the first transistor is coupled with the scan signal end, and a second gate of the first transistor is coupled with the scan signal end.

7. The pixel circuit according to claim 4, wherein the initialization signal end and the gating control end are the same signal end.

8. A display panel, comprising: a plurality of pixels, wherein each of the plurality of pixels comprises the pixel circuit according to claim 1.

9. The display panel according to claim 8, comprising a gating signal line;
wherein the gating control end of each of the plurality of pixels is coupled with the same gating signal line.

10. The display panel according to claim 8, comprising: a plurality of reset lines and a plurality of gate lines;
wherein reset signal ends of pixel circuits in a row of pixels are coupled with one of the plurality of reset lines, and gate control ends in a row of pixels are coupled with one of the plurality of gate lines.

11. The display panel according to claim 10, wherein a reset control circuit is coupled with the reset lines, a gate driving circuit is coupled with the gate lines, and a source driving circuit is coupled with a gating signal line.

12. A display apparatus, comprising the display panel according to claim 8.

13. A driving method for the pixel circuit according to claim 1, comprising:
in a reset stage: a reset sub-circuit providing an initialization signal to the gate of the driving transistor and the anode of the light-emitting device in response to a signal of a reset signal end;
in a data writing stage: the compensation sub-circuit connecting the gate of the driving transistor and the second electrode of the driving transistor in response to the signal of the scan signal end;
in a light-emitting stage: the coupling sub-circuit changes the voltage of the gate of the driving transistor in response to the signal of the gating control end, so that the driving transistor generates the driving current according to the data voltage and the light-emitting device emits light under the action of the driving current.

14. The driving method for the pixel circuit according to claim 13, wherein:
each display frame comprises a first stage and a second stage, the driving method comprises: driving the pixel circuit in each pixel row by row to perform the reset stage and the data writing stage in the first stage;
controlling the pixel circuit in each pixel to perform the light-emitting stage in the second stage.
